(19) United States
(12) Patent Application Publication
(10) Pub. No.: US 2016/0217484 A9
(43) Pub. Date: Jul. 28, 2016

(54) CROSS-SITE ONLINE SHOPPING ASSISTANT

(71) Applicants: Ryan David Hudson, La Canada Flintridge, CA (US); GEORGE RUAN, Arcadia, CA (US)

(72) Inventors: Ryan David Hudson, La Canada Flintridge, CA (US); GEORGE RUAN, Arcadia, CA (US)

(21) Appl. No.: 14/074,707

(22) Filed: Nov. 7, 2013

Related U.S. Application Data
(60) Provisional application No. 61/796,345, filed on Nov. 8, 2012.

(51) Int. Cl. G06Q 30/02

(52) U.S. Cl. CPC G06Q 30/0222

(57) ABSTRACT

A shopping assistant for online shopping. The invention provides for a software system to assist consumers in automatically locating and systematically applying discount codes to electronic commerce platforms to obtain reduced prices. In a preferred embodiment of the invention, discount codes are automatically located, evaluated against a user's shopping cart, and evaluated for the best results for the consumer. In the preferred embodiment, information about the utility of discount codes is recorded to machine readable storage.

### BACKGROUND OF THE INVENTION

1. Field of the Invention

This invention relates to the field of online shopping. More specifically, the invention comprises an automated assistant technology to help shoppers easily find and receive the best price available.

2. Description of the Related Art

Thousands of merchants offer products for sale via the Internet through stores presented to consumers as websites, mobile websites, mobile applications and other electronically connected purchase environments. Many of these online merchant stores, also known as electronic commerce platforms or ecommerce sites, offer discounts to consumers who enter a specific code into a form box while shopping or to consumers who follow a specially formatted hyperlink or perform other actions to activate a discount. These Codes are often called ‘coupon codes’, ‘promo codes’, ‘discount codes’, or other many other terms. For purposes here, Codes will include any actions taken by a consumer to access a different price for all or a portion of the goods or services they are considering purchasing.

These Codes frequently offer things like free or discounted shipping or a lower price on an entire basket of products, a category of products, a specific product, a certain number of products, products over a certain value, or even a combination of products meeting some criteria. In some cases these Codes are advertised to consumers during the online shopping experience, but frequently they are hidden from most consumers and only known to those exposed to them through other channels.

To help consumers locate available Codes, Code Aggregator websites exist to aggregate Codes and make them searchable and discoverable by consumers. Code Aggregators often provide search tools to find Codes by merchant on the Code Aggregator website. A few Code Aggregators have developed web browser plugins or web browser extensions that display Codes while shopping on merchant websites (Browser Enhancements).

To use Codes from Code Aggregators, consumers identify a promising Code to use and copy the Code into the Code box on the merchant website and submit the Code typically by clicking a form button, frequently labeled ‘apply’.

While Code Aggregators make their best effort to keep the list of Codes and information describing their expected behavior accurate and up-to-date, frequently consumers attempting to use Codes from Code Aggregators encounter problems where a Code does not work, or does not work as described by the Code Aggregator. To compound the problem, the number of different Codes made available by the Code Aggregators can be significant making it a burden for a shopper to identify a working Code.

As a result, most consumers do not comprehensively test all of the Codes that could give them a better price. Just as one example, when trying Codes from a leading Code Aggregator on a leading domain name merchant's website. The 18^{th} code, with no description on what a consumer should expect, resulted in a price of $3.13 for a product that previously cost $14.17—a 78% savings. This experience is not uncommon.

### BRIEF SUMMARY OF THE PRESENT INVENTION

The present invention comprises a system to systematically identify and apply the best Codes on behalf of a consumer while shopping on electronic commerce platforms. The invention's primary benefit is to help consumers achieve the best price available without a large amount of time and effort. The invention's additional benefits include but are not limited to building and maintaining a crowd-sourced database of Codes that are understood to be working or applicable to certain shopping situations.

In a preferred configuration, customers shopping on electronic commerce platforms are presented with the option to automatically find and apply available Codes by clicking one special button added to the shopping experience by a web Browser Enhancement.

After clicking the special button the computer software of the invention begins systematically applying Codes to the consumer shopping cart on the merchant website. In the preferred configuration, a list of possible Codes corresponding to the merchant website and optionally related to the products contained in a user's shopping cart is retrieved from a remote server. In this embodiment, the remote server returns a prioritized ordering of the list containing one or more Codes to try along with, in some instances, configuration information about how to apply Codes to the merchant electronic commerce platform. In the preferred embodiment, this information retrieval occurs prior to clicking the special button to reduce latency for the user.

With a set of Codes and information about how to apply them, the software system of the invention begins systematically applying them to the merchant website, either one at a time, or if a merchant website supports it, with more than one at a time. In a case where the merchant website supports the application of one Code at a time, the software system adds a code to the Code box on the merchant website and simulates a click or other consumer interaction, as though the customer were entering the Code. The software system of the invention then listens for the response from the merchant website to understand whether the Code was accepted and optionally to detect the impact of the Code on the price.

Results from applying Codes can optionally be recorded locally within the software system or in a remote data storage capacity. In the preferred configuration results from applying codes are stored in a remote data storage that is subsequently used to inform the creation of lists of Codes for other customers or for use in other applications.

The software system of the invention uses results from applying Codes to decide which additional Codes should be tried, if any, with the primary objective being to reduce the total price to be paid by the customer using the software. A secondary objective of the software could optionally be to reduce the amount of time required to return a final result. A third objective of the software could be to adjust the price to meet a particular target or target range for a particular consumer and could be informed by a business relationship with the merchant or another reason why a specific price range is more desirable than just the lowest price.

### BRIEF DESCRIPTION OF THE DRAWINGS

FIG. 1 is a schematic view of one embodiment of the invention system.

FIG. 2 is an example of a typical electronic commerce platform with a discount code box during the checkout flow.

FIG. 3 depicts a typical electronic commerce platform with a button inserted by a Browser Enhancement as in one embodiment of the invention.

FIG. 4 depicts one embodiment of the invention as presented to the customer while applying a plurality of Codes to an electronic commerce platform.

FIG. 5 depicts one embodiment of the invention as presented to the customer reporting results of applying a plurality of Codes to an online commerce platform.

### DETAILED DESCRIPTION OF THE INVENTION

The following detailed description describes the present embodiments with reference to the drawings. In the drawings, reference numbers label elements of the present embodiments. These reference numbers are reproduced below in connection with the discussion of the corresponding drawing features.

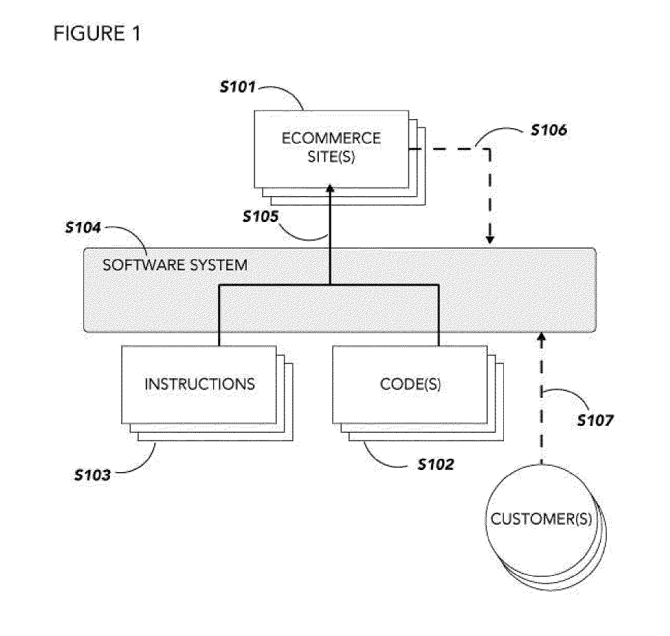

FIG. 1 describes one embodiment of the present invention. In FIG. 1, S101 identifies a plurality of ecommerce sites, also referred to as electronic commerce platforms, upon which the invention works. At present there are hundreds of thousands of such electronic commerce platforms ranging in size and scope from large multi-national online retailers like Amazon.com selling a wide assortment of product to small boutique operations selling a single product. Also included in this are mobile websites and apps or websites designed to be used on smaller screens, tablets, mobile devices, interactive televisions or other Internet connected stores.

S102 corresponds to a list of promotional, discount, or coupon code (Codes). In some cases these Codes could be multi-dimensional, contained within a special URL link or accessed by a certain user action. In the preferred embodiment, this list is intelligently arranged based upon information about a consumer's shopping cart and data previously collected about the effectiveness of the Codes.

S103 corresponds to instructions about how to apply codes to an electronic commerce platform. While many electronic commerce platforms have a similar structure to handle Codes, the specific computer code required to simulate user interaction with the site often requires electronic commerce platform-specific configuration information. To the extent that such information is needed it is include in these instructions. Additionally, instructions include other electronic commerce platform-specific information such as, but not limited to, how to interpret results, how many codes to process, timing between actions, and how to identify products in the cart.

S104 corresponds to the software system of the invention. The software takes instructions (S103) and Codes (S102) as input, and it uses this information to find a better price for the consumer. The invention software system optionally listens for results from the ecommerce website (S106) and input from the consumer (S107) as control signals.

S105 corresponds to the process by which the software system (S104) interfaces with the electronic commerce platform (S101) to systematically apply Codes. S105 combines the information of S102 and S103 with the control logic embodied in S104 to manipulate S101 in a desired manner to achieve the desired results as set forth in S104.

S106 corresponds to the feedback from the electronic commerce platform that can optionally be monitored by the software system S104. S106 most commonly includes messages displayed on the electronic commerce platform in response to submitting a Code. For example, the total price displayed on the cart may be reduced when a Code is successfully applied, or an error message may be displayed on the website when an invalid code is submitted. This information can be analyzed and recorded.

S107 corresponds to optional user input. In the preferred embodiment, one example is initiating the software system on an electronic commerce platform, though in other embodiments the software system in S104 could be triggered without user input.

Note that the location of logic and storage, while separated in this diagram can be combined, separated, or even sub-divided in different embodiments of the invention. For example, the software system S104 could include software code contained both on the user client (e.g., as a web browser enhancement) and in software code loaded from a remote server (e.g., remotely loaded javascript computer files). In fact in the preferred embodiment of the invention, S104 is sub-divided as described.

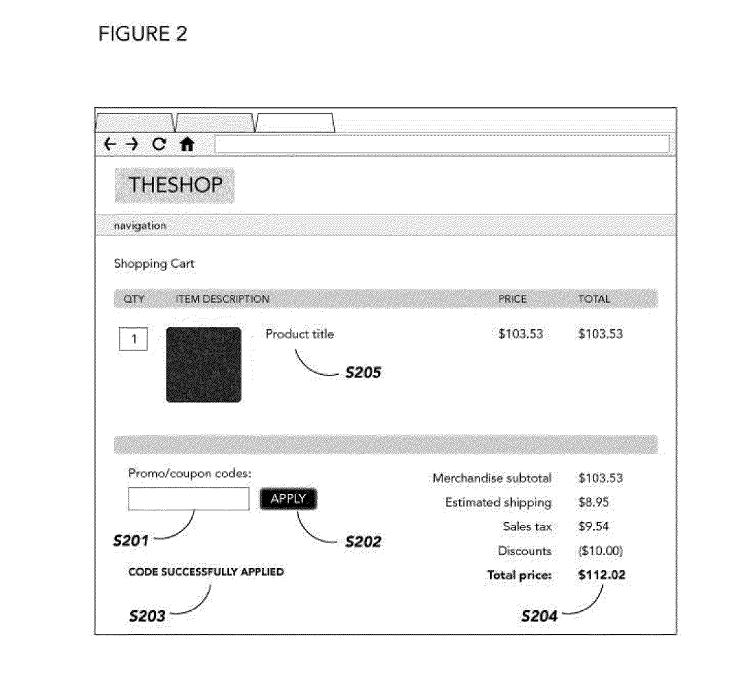

FIG. 2 depicts a typical electronic commerce platform's shopping cart without enhancement from the present invention.

S201 shows a Code entry box which is typically formatted as an html input box that accepts text input.

S202 shows a button that a user clicks to submit a Code to the site to apply a Code to the shopping cart. On most electronic commerce platforms this triggers a handler that exchanges information about the validity of the Code that has been submitted.

S203 shows an example message displayed by the electronic commerce platform in response to a Code being applied on the site that indicates the current status of a Code. Some sites display more than one message—others display none.

S204 shows the total price for the products in the cart, typically including tax and shipping if that information is known.

S205 shows the title of a product in the cart. Frequently this title will include a hyperlink to a product details page with more information about the product.

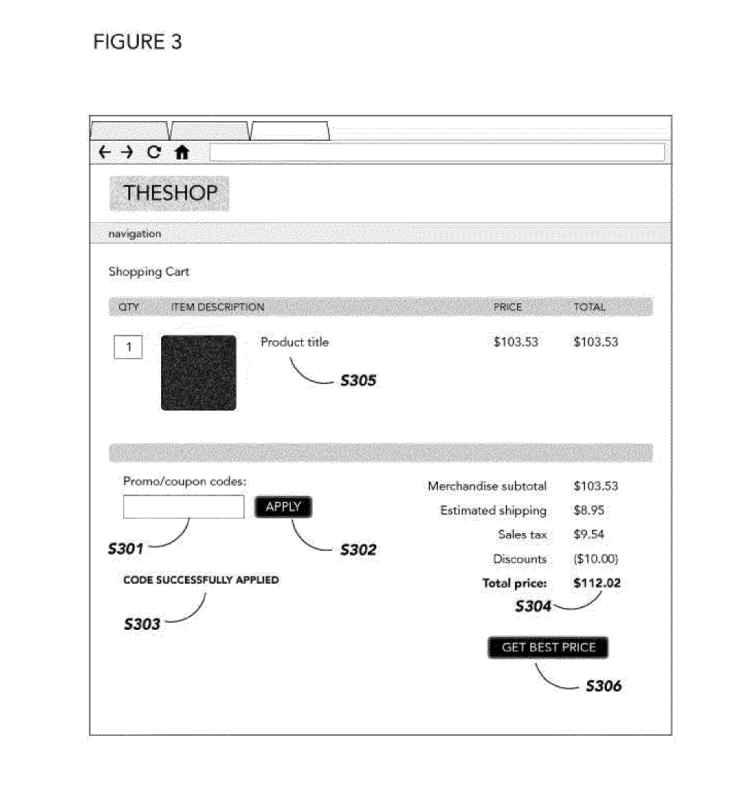

FIG. 3 depicts a typical electronic commerce platform's shopping cart with the present invention dynamically displayed by the software system.

S301, S302, S303, S304, and S305 are comparable to S201, S202, S203, S204, and S205.

S306 shows a special button inserted by the software system of the present invention. In one embodiment of the invention, a user clicking on the button shown by

S306 triggers the software system to systematically apply Codes to the website. Alternatively, in other embodiments, Codes could be applied without user interaction or after an alternate user interaction.

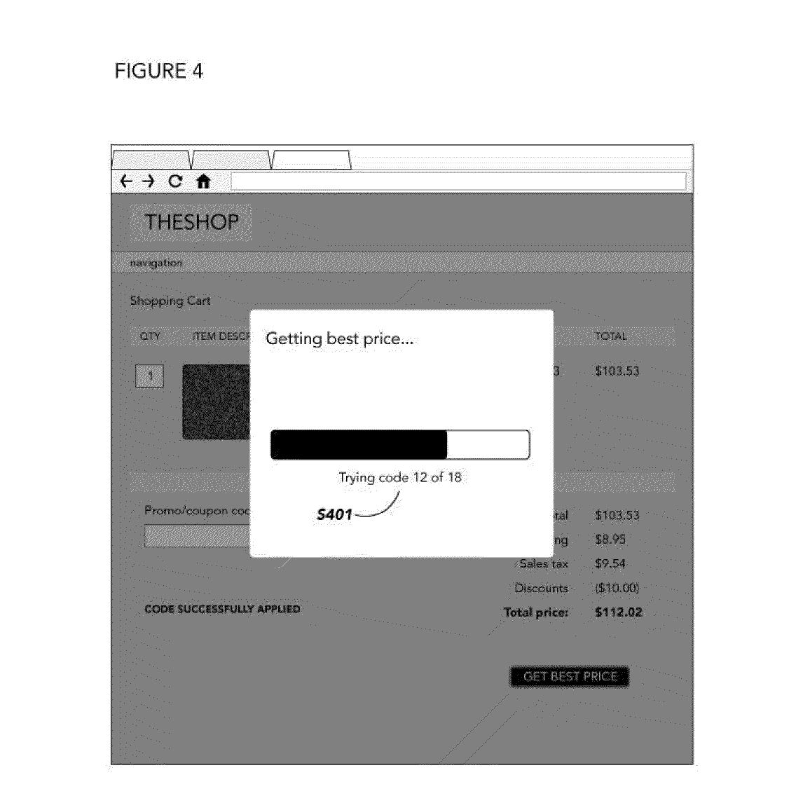

FIG. 4 depicts one embodiment of feedback displayed to the user after the software system has initiated applying Codes to the website, but before completion. In another embodiment this feedback could be removed.

S401 shows a progress bar and text feedback to the user while the software system systematically applies Codes to the website and records the results. In this particular embodiment, while the user sees this message, the software system is applying one or more Codes to the website by using instructions to apply a Code(s) to the merchant website, submit them for evaluation, and optionally record the results to local and/or remote computer storage for evaluation.

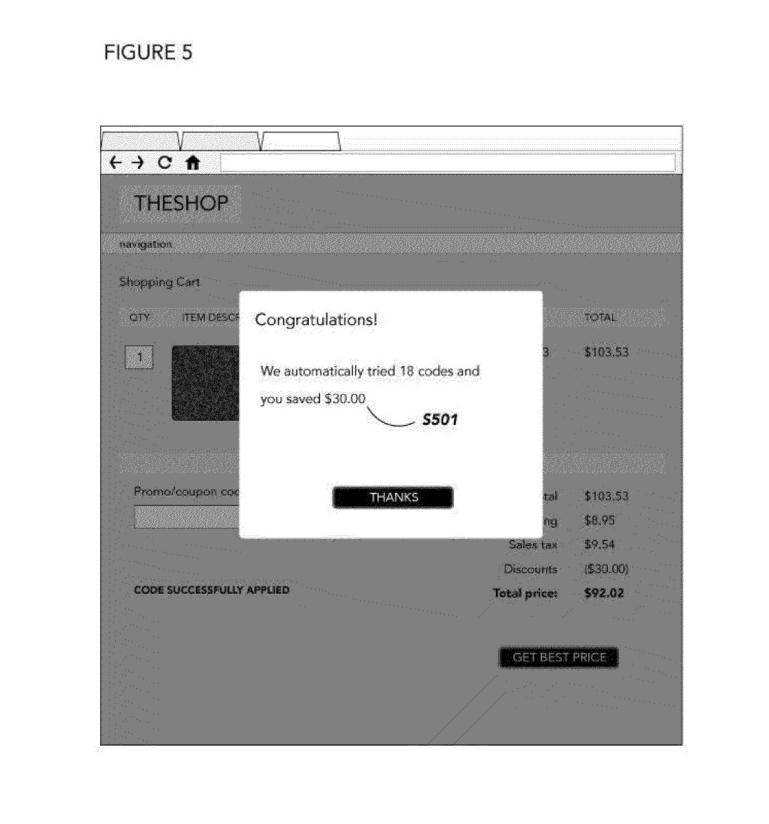

FIG. 5 depicts one embodiment of feedback displayed to the user after the software system has completed applying Codes to the website.

S501 shows a message to a user indicating that the software system has successfully evaluated 18 Codes and applied Code(s) resulting in savings to the user. To reach this state, the software system has systematically applied Code(s) in an optionally prioritized manner, optionally evaluating the success or failure of the application of Code(s) and optionally has selected an optimal set of Code(s) to apply to create the final state. Depending on information controlling the application of Codes to a specific site, an embodiment of the system could use one or more of these steps to create the final state of a shopping cart on one merchant website while applying a different one or more of these steps on another merchant website.

Having described our invention, we claim:

1. A software system to systematically apply one or more discount codes to an electronic commerce platform comprising:
a. a machine-readable list containing one or more codes;
b. information about how to apply one or more codes;
c. software to systematically apply one or more codes;

2. A software system as recited in claim 1, where one or more codes are automatically applied to the electronic commerce platform.

3. A software system as recited in claim 1, where one or more codes are automatically applied to the electronic commerce platform after one or more user instructions.

4. A software system as recited in claim 1, where the list of codes is retrieved from a remote machine-readable data source, a machine-readable storage local to the user, or some combination thereof

5. A software system as recited in claim 1, where information about how to apply codes is mapped to a specific electronic commerce platform or set of electronic commerce platforms.

6. A software system as recited in claim 1, where the computer software to systematically apply codes is partially or fully stored or executed on the user's computing system.

7. A software system as recited in claim 1, where the computer software to systematically apply codes is partially or fully stored or executed on a remote computing system with at least some of the results delivered to a user's computing system.

8. A software system as recited in claim 1, where the electronic commerce platform is a mobile website or application.

9. A software system as recited in claim 1, where the result of applying each code is recorded to machine-readable storage and optionally used to determine the best combination of one or more codes to apply to receive the lowest price.

10. A software system as recited in claim 1, where one or more codes are removed after being applied as a part of the systematic application of codes.

11. A software system that collects and records data from one or more consumers about the results of applying one or more codes to electronic commerce platforms comprising:
a. machine-readable data storage
b. computer software to observe the results of applying codes
c. information about the electronic commerce platform and/or shopping cart to which codes were applied

12. A software system as recited in claim 11, where results data is collected and used to build a sorted list of codes organized by one or more dimensions.

13. A software system as recited in claim 11, where results data is collected and used to verify if codes are currently functional.

14. A software system as recited in claim 11, where results data is collected to interpret the current status of a code.
